(19) United States
(12) Patent Application Publication
(10) Pub. No.: US 2018/0240409 A1
(43) Pub. Date: Aug. 23, 2018

(54) LED MICRODISPLAY

(71) Applicant: SCT TECHNOLOGY, LTD., Grand Cayman (KY)

(72) Inventors: Eric LI, Milpitas, CA (US); Juinn-Yan CHEN, Milpitas, CA (US); Yi ZHANG, Milpitas, CA (US); Heng LIU, Milpitas, CA (US)

(21) Appl. No.: 15/901,712

(22) Filed: Feb. 21, 2018

Related U.S. Application Data
(60) Provisional application No. 62/461,500, filed on Feb. 21, 2017.

(51) Int. Cl. G09G 3/3283

(52) U.S. Cl. CPC G09G 3/3283; G09G 2330/021; G09G 2320/0285; G09G 2320/0693; G09G 2320/0673; G09G 2320/0242; G09G 2310/0291

(57) ABSTRACT

An LED display device contains an LED display having an array of LED pixels and an electrical system. The electrical system includes a transmitter, a plurality of receiver chips each having a receiver circuitry, and a plurality of driver chips each having a driver circuitry. Alternatively, the receiver circuitry and the driver circuitry are integrated on one chip so that the electrical system contains a number of such chips. The transmitter comprises a memory storing a Gamma correction lookup table and a buffer for storing a LED calibration data. The transmitter receives data packets from a data source, performs Gamma encoding and LED calibration to the data packets. The receiver circuitry is coupled to the transmitter and receives data packets from the transmitter and sends PWM data to a group of LED drivers, which provides current sources to drive the LED array.

### RELATED APPLICATION

This application claims the benefit of priority under 35 U.S.C. § 119 to U.S. Provisional Application No. 62/461,500, filed on Feb. 21, 2017, the entire contents of which are incorporated herein by reference.

### TECHNICAL FIELD

This disclosure relates generally to LED microdisplay devices and methods for operating the same. In particular, this disclosure relates to devices and methods for transmitting data to and for driving a LED microdisplay device.

### RELATED ART

LED displays are used in various applications ranging from outdoor large display panels to microdisplays for hand-held display devices. While large display panels may employ arrays of discreet LEDs, a microdisplay often uses monolithic LED arrays to for their small sizes and fine pixel pitches. U.S. Pat. No. 8,557,616 discloses methods of making a microdisplay mounted on an active matrix panel. However, the turn-on voltages of LEDs on an active matrix vary according to the distance between each LED and n-electrode, which leads to variations in the lifetime and emitting wavelength of individual LEDs in the microdisplay. Accordingly, there is a need for micro LED display that has a uniform color purity, good durability, and high power efficiency.

In addition, there are numerous ways to operate LED display panels. U.S. Pat. Nos. 9,747,872 and 9,704,430 disclose an electrical system that include a transmitter (aka sendbox) for distributing data (e.g., video data), a bridge chip (aka first receiver), which receives data from the transmitter and further transmits the data to the receiver chips (aka second receiver.) The receiver chips further process and send data to the array of LED drivers. Data is transmitted among the transmitter and numerous receivers through SerDes links. However, the LLP SerDes speed is slow, e.g., 307.2 Mbps. The bridge chip is needed to distribute 1 Gbps data to several SerDes links. In addition, such a system has a relative large footprint because, for example, each second receiver carries a flash memory.

A large display is assembled together with relative large a plurality LED modules, i.e., LED tiles. Each of these tiles have its designated receiver chip(s) that performs functions such as R/G/B calibrations and gamma calculation. Data communication amongst the tiles are through the cables. This configuration allows the replacement of an individual LED tile with its associated receiver chip(s). Further, power consumption for a large LED display, although an important performance consideration, is not necessarily a constraint. However, for a microdisplay not much larger than a person's palm and powered by a small battery, small size and low power consumption is crucial. Accordingly, there is a need for LED display device that has a simply electrical system and a lower power consumption.

### SUMMARY

In some embodiments, the microdisplay of this disclosure employs one or more array of quantum dot LEDs or organic LEDs with spacing-saving topology and direct current driver architecture, delivering high video brightness dynamics and power efficiency. Its modular design also allows manufacturing different size displays using the same module.

In further embodiments, the LED array may be arranged in a common anode scan configuration, in which anodes of a plurality of LEDs of a same color in a same row are operatively connected to a power source via a switch while cathodes of the plurality of LEDs of the same color in a same column are tied to the output of a current driver circuit. As such, the LEDs have a same supply voltage. In such a configuration, an NMOS driver is often used as the current sink. An NMOS is preferable over a PMOS because NMOS has a larger current capacity and a lower Rds(on) for a given design geometry.

Alternatively, the LED display may use a common cathode topology, in which cathodes of a plurality of LEDs in a same row are connected to a scan switch via a common cathode bus (i.e., a scan line) and the anodes of a plurality of LEDs of a same color in a same column are connected to a driver circuit via a common anode bus.

One embodiment of the LED panel of the current disclosure has a first layer comprising an LED array having rows and columns of interconnected LED pixels, a second layer comprising a plurality of driver circuits, and a plurality of cathode buses and a plurality of anode buses disposed between the first layer and the second layer. Each driver circuit is connected to a power source and comprises an on-off switch. Each LED pixels have a red LED, a green LED, and a blue LED, and each LED has a cathode and an anode. Each of the plurality of driver circuits outputs a constant current to one of the plurality of cathode buses or to one of the plurality of anode buses.

In a further embodiment of a common cathode configuration, each anode bus connects anodes of LEDs of a same color in a column while each cathode bus connects cathodes of the red LEDs, the green LEDs, and the blue LEDs in a row. Each anode bus receives a constant current outputted from the driver circuit and each cathode bus is connected to the on-off switch in the driver circuit.

In some embodiments, the driver circuit includes a plurality of pulse width modulation (PWM) engines, a register that stores driver circuit settings, and a plurality of gain adjustable current sources. The register provides gray scale values to the PWM engines and global gain adjustment settings to the current sources. The PWM engine receives gray scale values from the configuration register. It also receives R/G/B PWM data, a global clock signal from the receiver circuitry. The PWM engine then provides signals to the gain adjustable current sources. The current sources provide a plurality of current outputs to drive the LED array.

In one of the embodiments in this disclosure, the LED display device contains an electrical system and an LED display having one or more arrays of LED pixels. The electrical system includes a transmitter, a plurality of receiver chips each having a receiver circuitry, and a plurality of driver chips each having a driver circuitry. Alternatively, the receiver circuitry and the driver circuitry are integrated on a chip (i.e., “LPU,” “LPU chip,” or “integrated receiver/driver chip”) so that the electrical system contains a number of LPU chips. The transmitter has a memory storing a Gamma correction lookup table and a buffer for storing a LED calibration data. The transmitter receives data packets from a data source, performs Gamma encoding and LED calibration to the data packets. The receiver circuitry is coupled to the transmitter and receives the data packets from the transmitter and sends PWM data to a group of LED drivers, which provides current sources to drive the LED array.

In another embodiment, the transmitter is coupled to a flash memory storing the Gamma correction lookup table and the LED calibration data. The flash memory provides the Gamma correction lookup table and the LED calibration data to the transmitter upon power up.

In certain embodiments, the transmitter and the plurality of receivers are serially connected using a plurality of transformerless serial links, e.g., SerDes links.

In further embodiments, the array of LED pixels are bonded to a number of LPU chips and the group of LED drivers on the LPU chips are connected to the array of LED pixels. The LPU chips in turn are bonded to a substrate. The substrate has the transmitter mounted thereon and a plurality of connection points for receiving external feeds to the LED display device, such as a human interface cable, a power cable, or a video source cable. The LED array is a monolithic quantum dot LED array or a monolithic organic LED array. The LED array is connected to the driver circuitry in either a common anode or a common cathode configuration.

In still other embodiments, the receiver circuitry receives data packets from a data source and generates PWM data. It has an analog front-end circuit that performs signal sampling, clock recovery, and de-serialization of the data stream, an alignment circuit for aligning the de-serialized data stream, a decoder for decoding the data stream from the alignment circuit, and a first-in-first-out circuit coupled to the decoder for outputting the decoded data stream. The decoded data stream is then assembled to generate PWM data.

In still additional embodiments, the driver circuitry contains a double buffer receiving PWM data and the clock signal from the receiver circuitry, a plurality of PWM engines coupled to the double buffer and receive the PWM data and the clock signal form the double buffer, a plurality of current sources coupled to and driven by the plurality of PWM engines, and a plurality of current gain adjustment circuits coupled to the plurality of current sources. The current sources are gain adjustable and can output constant current to drive the LED array.

### BRIEF DESCRIPTION OF THE DRAWINGS

The teachings of the present invention can be more readily understood by considering the following detailed description in conjunction with the accompanying drawings.

FIG. 1 is a top view of monolithic LED array.

FIG. 2 illustrates a monolithic LED array coupled to an array of driver chips through an interconnect circuitry.

FIG. 3 illustrates certain interconnections in the device in FIG. 2.

FIG. 4 shows interconnections amongst LEDs in the monolithic LED array of 40×16 LED pixels.

FIG. 5 illustrates an assembly containing two monolithic LED modules.

FIG. 6 illustrates an assembly of two monolithic LED modules and the corresponding driver chips.

FIG. 7 is a schematic view of the LED modules mounted on driver chips.

FIG. 8 is a schematic diagram showing an embodiment of the electrical system in the current disclosure.

FIG. 9 is a schematic diagram of the transmitter in the current disclosure.

FIG. 10 is a schematic diagram showing another embodiment of the electrical system in the current disclosure.

FIG. 11 illustrates an embodiment of a chip that integrates receiver circuitry and driver circuitry (aka “Light Processing Unit” or “LPU chip”) in this disclosure.

FIG. 12 illustrates an exemplary driver circuitry on the LPU.

FIG. 13 is a schematic diagram showing certain components on the LPU.

FIG. 14 is an assembly with of the LED modules, the LPU chips, and a substrate (aka backboard) of the LED display device.

FIG. 15 illustrates the layout of the LPU chips on the substrate and connections therebetween.

FIG. 16 illustrates components and traces on the side of the substrate opposite to the LPU chips.

### DETAILED DESCRIPTION

Reference will now be made in detail to embodiments of the present disclosure, examples of which are illustrated in the accompanying drawings. It is noted that wherever practicable, similar or like reference numbers may be used in the drawings and may indicate similar or like elements.

The drawings depict embodiments of the present disclosure for purposes of illustration only. One skilled in the art would readily recognize from the following description that alternative embodiments exist without departing from the general principles of the present disclosure.

Used herein, the term “couple,” “couples,” “connect,” or “connects” means either an indirect or direct electrical connection unless otherwise noted. Thus, if a first device couples or connects to a second device, that connection may be through a direct electrical connection, or through an indirect electrical connection via other devices or connections. Further, an “LED module” refers to a standard-size array of LED pixels that can be assembled together to form a larger LED panel. In addition, “an LED array” means an array of LED pixels. A receiver means a receiver circuitry, either on a chip that does not contain a driver circuitry or on a chip having both the receiver circuitry and a driver circuitry. Likewise, a driver means a driver circuitry, either on a chip that does not have a receiver circuitry or on a chip having both a receiver circuitry and the driver circuitry.

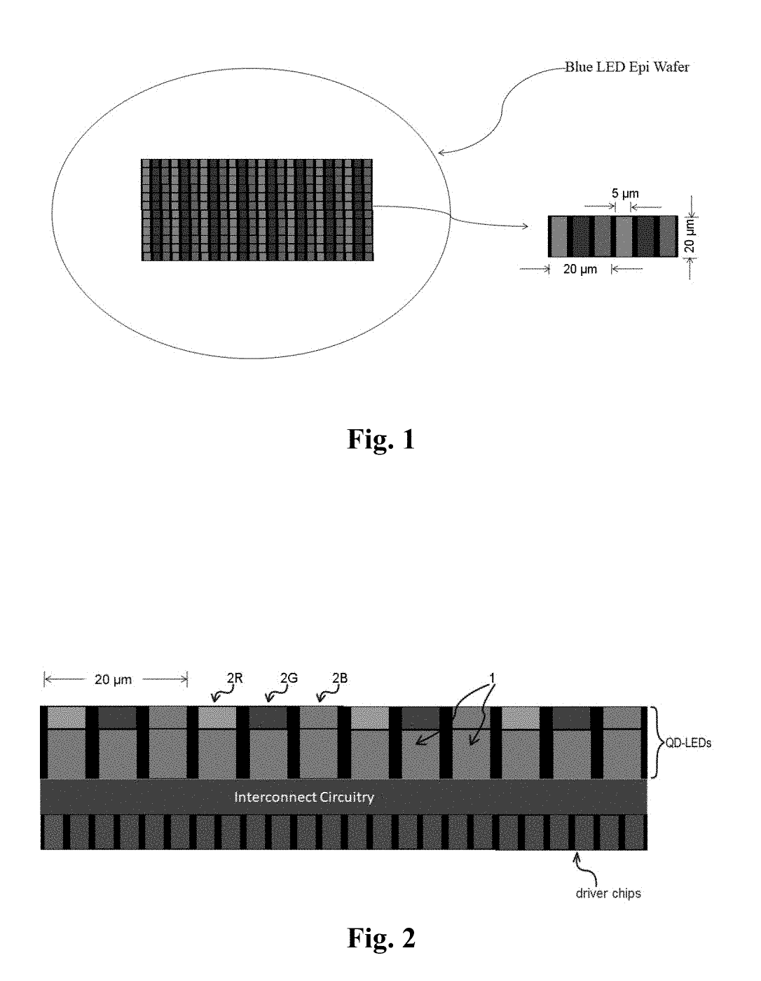

This disclosure presents LED display devices made of LED modules, including monolithic LED modules for making microdisplays. Certain embodiments of the monolithic LED array and assemblies thereof in this disclosure are described with reference to FIG. 1-7. FIG. 1 is a top view of monolithic LED array of the current disclosure. FIG. 2 is a schematic illustration of a side view of an exemplary device containing a QD-LED array of FIG. 1. In this embodiment, an array of blue LED (1) is manufactured on an epitaxial wafer. The epitaxial wafer is, e.g., 100 mm in diameter. Quantum dot materials (2R, 2G, and 2B) that respectively cause the emission of red, green, and blue lights are applied on top the blue LEDs to form quantum dot LEDs, i.e., QD-LEDs. The QD-LEDs are arranged in a manner that forms rows and columns of QD-LED units, forming a QD-LED array. Each QD-LED unit (i.e., pixel) has a red, a green, and a blue QD-LED, collectively referred to as QD-LEDs. In the exemplary embodiment in FIG. 1, each pixel is of 20 microns by 20 microns in size. Each QD-LED in the pixel has a size of 20 microns in length and 5 microns in width. The quantum dot material contains quantum dot particles in the nanometer range and a host material such as photoresist, epoxy, or silicone, etc. The size of the quantum dot particles are tailored so that these particles produce the desired color spectrum when excited by the blue LED emission.

The QD-LED array can be processed to form electronic devices. FIG. 2 shows the QD-LED array mounted on a plurality of driver chips via an intermediate layer containing the interconnect circuitry.

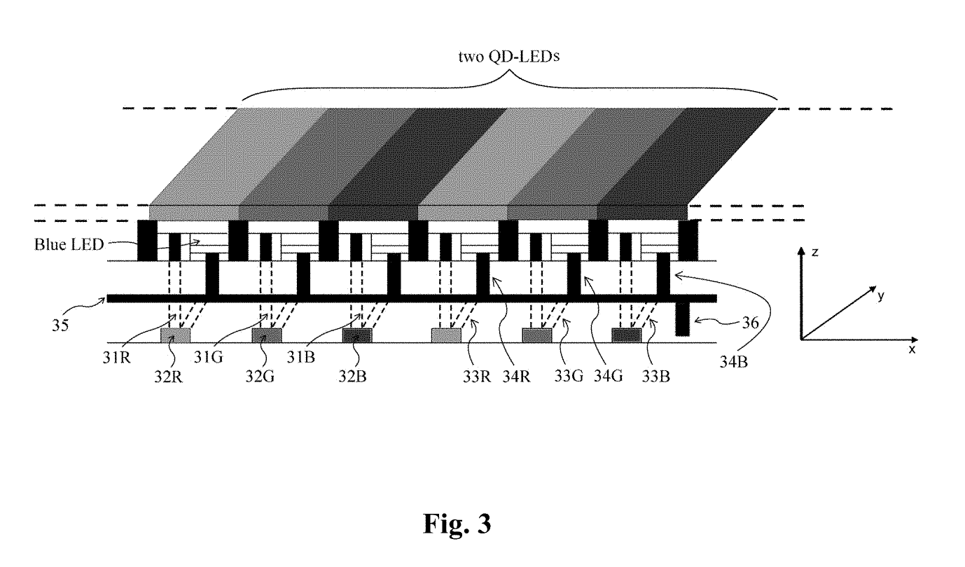

FIG. 3 provides more details of the QD-LED array and the intermediate layer containing the interconnect circuitry. FIG. 3 shows two QD-LED units in a same row arranged in the X-direction. Although not shown in FIG. 3, it is understood that QD-LED units extend in both X- and Y-directions to form the LED array. In the Z-direction, the QD materials are disposed on the top of the blue LEDs. Connection lines from the anodes of the QD-LEDs (31R, 31G, or 31B) extend downward in the Z-direction and are connected to red, green, or blue bonding pads (32R, 32G, or 32B), referred to collectively as anode bonding pads. The anode bonding pads for LEDs of the same color in different rows are connected to a common anode bus (33R, 33G, or 33B), which extends in the Y-direction under the LED array. On the other hand, cathodes of QD-LEDs in a same row are connected via lines (34R, 34G, or 34B) to a common cathode bus (35) extending in the X-direction, i.e., a scan line. Each row has its own corresponding scan line.

Accordingly, the intermediate layer contains a plurality of scan lines arranged in parallel in the Y-direction and a plurality of parallel common cathode buses arranged in parallel in the X-direction. The plurality of scan lines may reside in a same depth relative to each other, i.e., the first depth. The plurality of common cathode buses may be in another same depth relative to each other, i.e., the second depth. But the first depth and the second depth are not the same.

Further, each scan line is connected to a scan bonding pad (not shown) via a through hole in the intermediate layer (36). The anode bonding pads and the scan bonding pads are connected to the driver circuitry on the driver chip (not shown). The QD-LED array and the intermediate layer may be manufactured on a same wafer using known photolithographic methods. The driver chips may also be fabricated on a wafer, e.g., a Si wafer, which is coupled with the intermediate layer at corresponding bonding pads. The bonding process can be done by semiconductor wafer bonder with the proper placement precision.

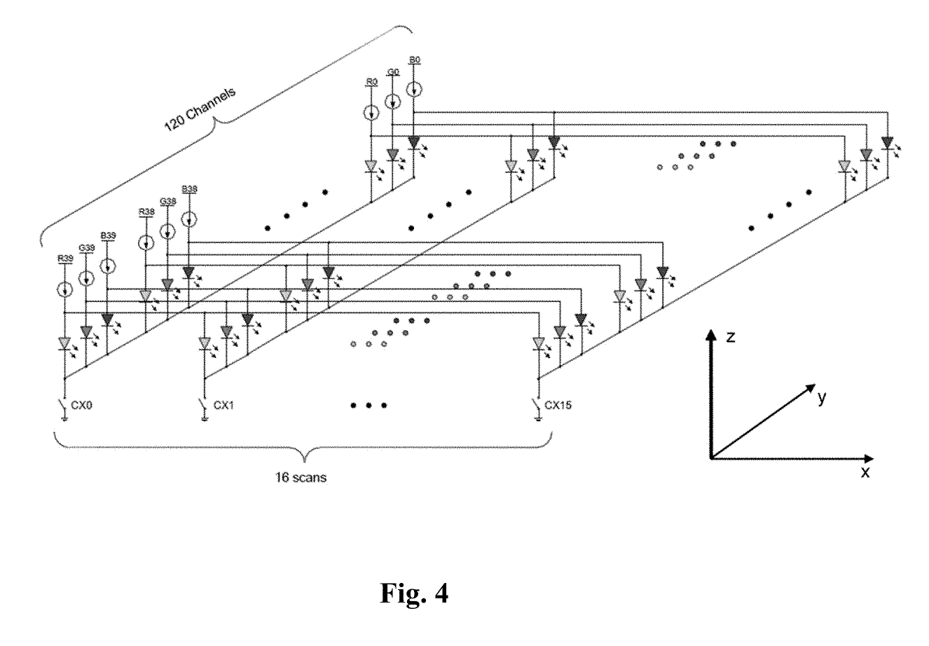

FIG. 4 is another depiction of the interconnections amongst the LEDs in the QD-LED array of 120×16 LEDs (i.e., 40×16 LED pixels). In this case, the array has 16 rows and 120 channels. Each row has 40 QD-LED pixels. Cathodes of that 40 QD-LED pixels in a row are connected to one of the 16 scan lines that corresponds to that row. Each scan line is also connected to a corresponding on-off scan switch, i.e., one of CX0 to CX15. Each channel connects anodes of 16 QD-LEDs with one of the 120 current sources (i.e., one of R0, G0, B0 . . . R39, G39, and B39). The current sources are gain adjustable so that the current output can be constant. The scan line corresponds to the scan line (35) in FIG. 3 while each channel corresponds to a common anode bus (33R, 33G, or 33B). The current sources as well as the switches in FIG. 4 may be installed on the driver chip.

The QD-LED array in FIG. 4 can be operated at 16 scan rate. This configuration is referred to as “common cathode.” Alternatively, the array can be connected in a “common anode” configuration, in which anodes of 120 diodes in 40 pixels in a same row are connected to a scan switch while the cathodes of 16 diodes of the same color in a same column are connected to a power source.

In other embodiments of the current disclosure, the LED array may use organic LED (OLED) instead of QD-LEDs. In such cases, each QD-LED in the QD-LED array shown in FIGS. 1-4 is replaced by an OLED of the same color. The interconnections amongst the OLEDs and between the OLED array with the LPU chip remain the same.

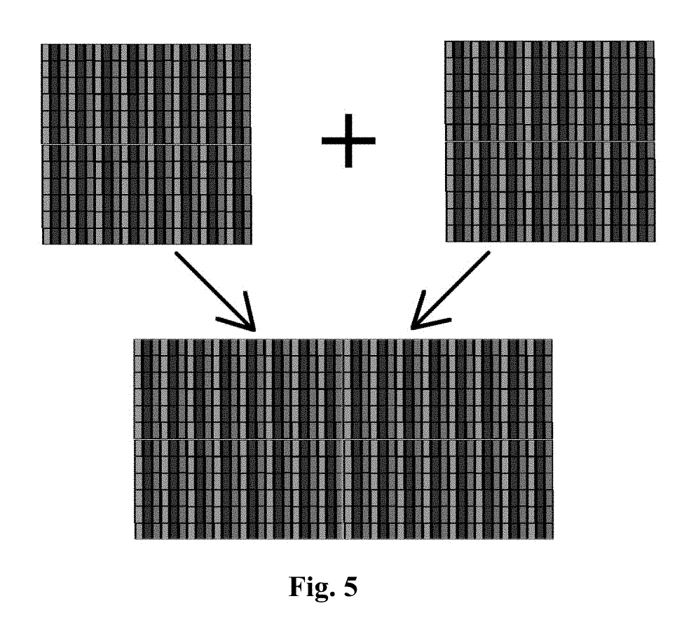

One aspect of the current disclosure is that the LED microdisplay is made by assembling multiple LED modules. For example, a 4K microdisplay with 3840×2160 pixels can be constructed using two LED modules of 1920×2160 pixels each, as shown in FIG. 5.

The size of LED module is primarily determined by practical manufacturing limitations for high yield processes, including the wafer size of LED, OLED, driver wafer and pixel yields. Since the LED or OLED wafers are different from the Si driver wafer in these aspects, the size of a basic LED or OLED module may differ from that of the driver chip module.

For example, an LED module of about 40 mm by 40 mm has 1920×2160 pixels of 20 micron pitch size. A driver chip of about 4 mm by 20 mm in size can drive 192×1080 pixels so that 10 driver chips may drive 1920×1080 pixels and a 4K microdisplay requires 40 such driver chips.

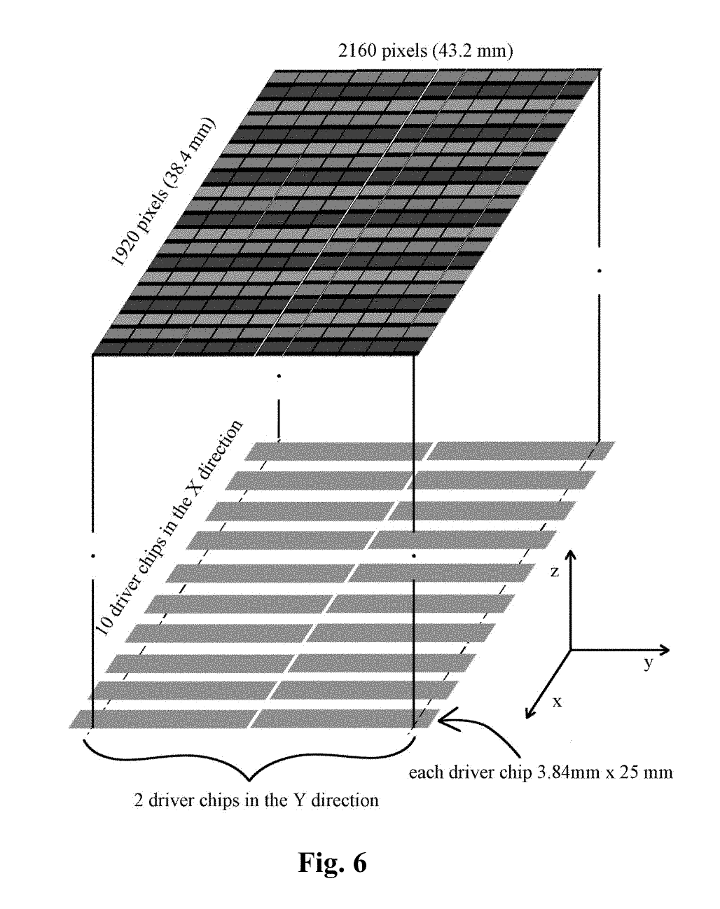

FIG. 6 depicts a 1920×2160 pixel LED module and its corresponding 20 Si driver chips with exemplary dimensions. Note that the Si driver chips are layered side-by-side in a 10×2 format, having a footprint of 38.4 mm by 50 mm. The LED module of 38.4 mm by 43.2 mm in size are disposed on the Si driver chips via the interconnect circuitry. Each Si driver chip is bond to the LED module. The method of bonding can be by metal bonding using Sn, AuSn, SnPb, etc. or by ACF/ACP processes. The peripheral portion of the driver chip is not covered by the LED module so that the exposed area can accommodate the external connections to the driver chip.

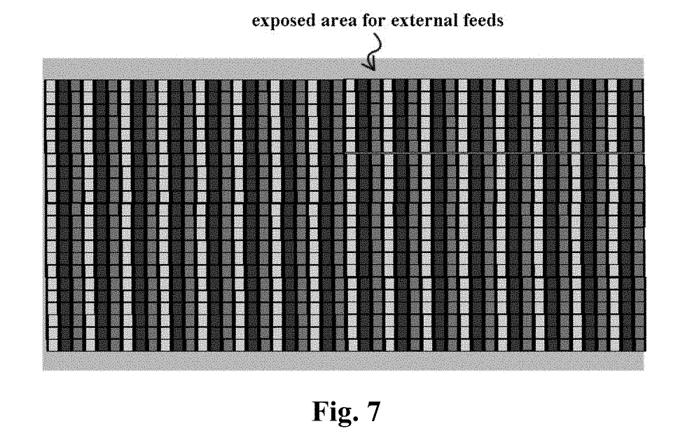

FIG. 7 shows an assembly having two LED modules and their associated LPU chips that forms a micro-display of 76.8 mm by 43.2 mm. Edges of the LPU chips extending out under the boundary of the LED modules are used for external content feeds, power connections, etc.

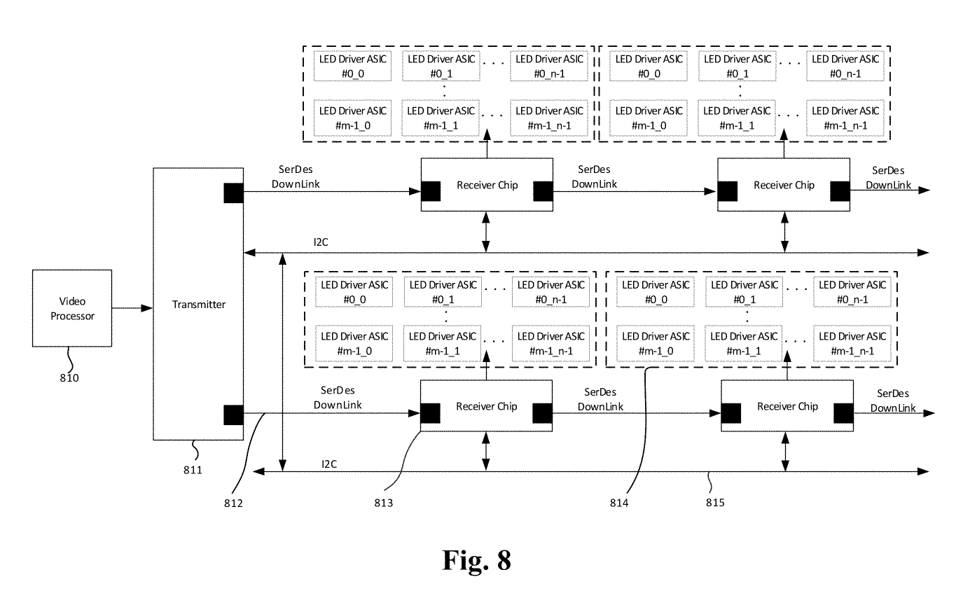

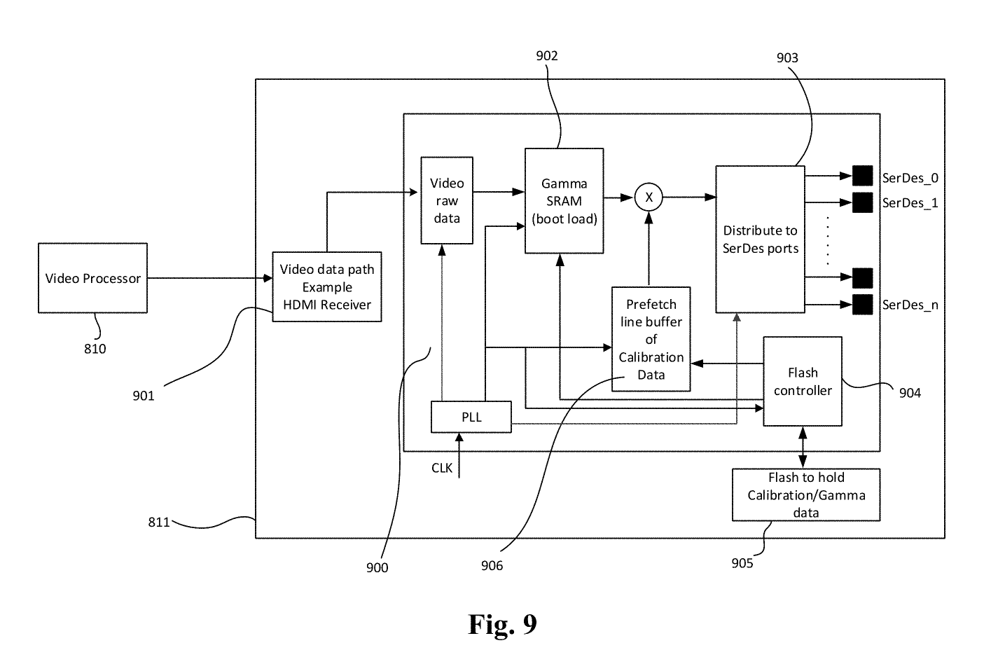

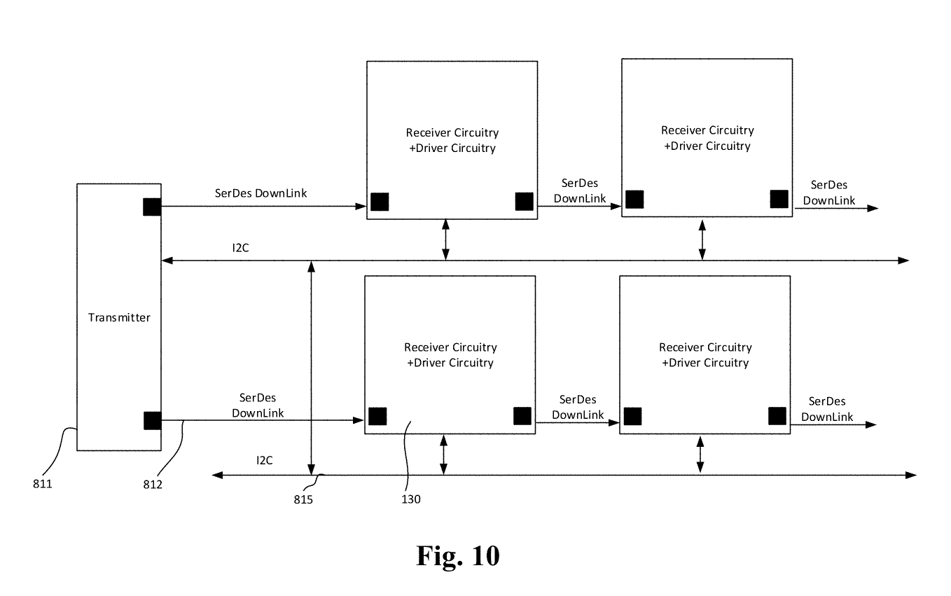

An LED display device, particularly an LED microdisplay, requires an electrical system of small footprint and low power consumption. FIG. 8-16 present embodiments of such electrical systems. FIG. 8 shows a schematic block diagram of a system for transmitting data to and driving the LED display. FIG. 9 shows an exemplary configuration of the transmitter in the system of FIG. 8. FIG. 10 is a schematic block diagram of an exemplary receiver of FIG. 8.

Referring to FIG. 8, the electrical system includes a video processor (810), a transmitter (811), a plurality of receiver chips (813), and a plurality of LED driver arrays (814) driving a plurality of LED modules (not shown). The video processor (810) may be any video data source, e.g., a VCR player, a camcorder, a HD-DVD player, and/or a satellite. It provides video data to the transmitter (811), which transmits data to the receiver chips (813) via a plurality of transformerless serial links (812). The transformerless serial link 182 employs DC-coupled low voltage differential signal (LVDS) technology and low-bandwidth phase-locked loop (PLL). Each of the receiver chips (813) further sends data to an array of drivers, which are fabricated on one or more driver chips. The driver chips in turn are bonded to the monolithic LED array as shown in FIG. 6.

In the embodiment of FIG. 8, an example of the transformerless serial link (812) is a serializer/deserializer (SerDes) link, which converts data between serial data and parallel interfaces in each direction. SerDes are used for both the downlink and uplink in the electrical system disclosed in U.S. Pat. Nos. 9,704,430, and 9,747,872. In this embodiment, only the downlink uses SerDes, carrying the data stream. The receiver chips (813) are connected to a lower-speed shared bus (815) for transmitting control data and for read-back, which in turn is connected to the transmitter (811). The shared bus has a much lower power consumption in comparison to the SerDes link. An example of the shared bus is the I2C bus.

FIG. 9 illustrates components in the transmitter (811) as well as the connection between the transmitter (811) with the video processor (810). The transmitter (811) is coupled with a data port (901), which receives data from the video processor (810). FIG. 9 shows a HDMI (High-Definition Multimedia Interface) receiver as the data port for illustrative purposes. The transmitter (811) is coupled with a flash memory (905), which holds calibration data and a Gamma correction lookup table. The PPL circuit receives a clock signal and generates output signals to control components in the transmitter (900).

In a power up stage, the controller (904) sends the calibration data into a line buffer (906) and sends the Gamma correction data to a SRAM (902). The raw video data is Gamma encoded according to the Gamma correction data in the SRAM. The Gamma encoded data is then calibrated with calibration data from the line buffer (906) to obtain the R/G/B data. The RGB data is further distributed to SerDes link ports (SerDes_0 to SerDes_n) and from there sent via the SerDes downlink (FIG. 8, 812) to the plurality of receiver chips (FIG. 8, 813). Note that this configuration does not require a video frame buffer in the transmitter.

FIG. 10 illustrates a further embodiment of the electrical system in the current disclosure. In this embodiment, the receiver circuitry and the driver circuitry are integrated on a same chip (130), hereby named “Light Processing Unit” or “LPU.” Since the Gamma SRAM resides in the transmitter (811), the LPU does not carry the SRAM.

The receiver circuitry on the LPU receives the Gamma encoded, calibrated video data from the SerDes downlink, and performs clock recovery, data alignment, and data decoding. The decoded data is sent to the driver circuitry. In this embodiment, the decoded data is encoded again to have a different ID and passed on the LPUs downstream.

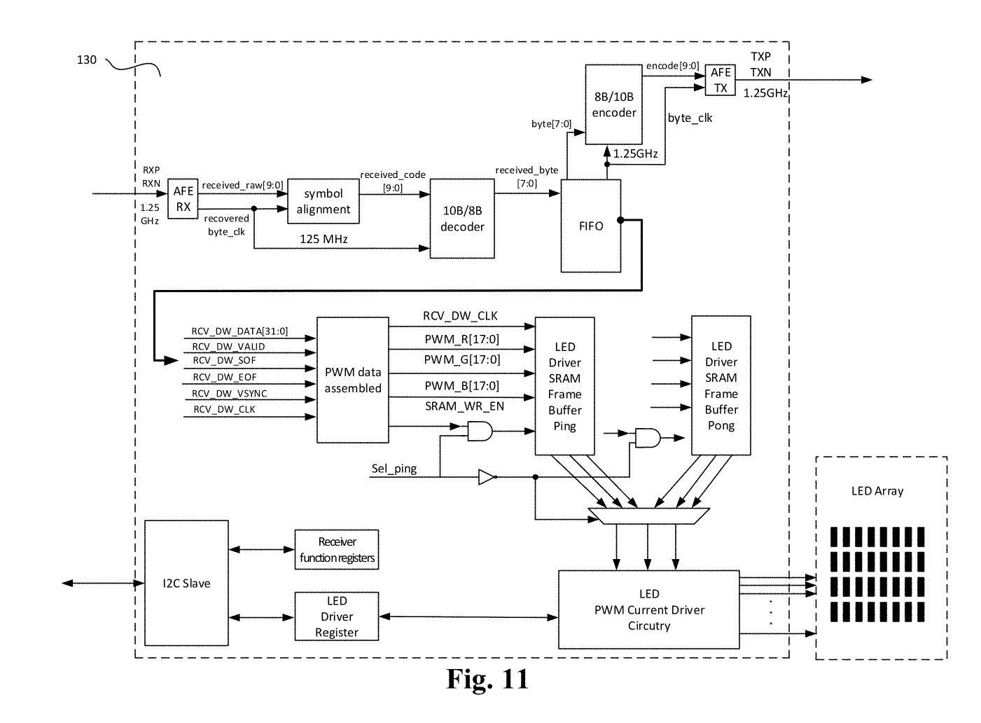

FIG. 11 details one embodiment of the LPU in this disclosure. The SerDes downlink transmits a serial 10-bit data stream to the analog front-end circuit of the receiver circuitry (AFE RX), which performs high-speed signal sampling, clock recovery, and de-serialization. In clock recovery, the AFE RX generates a serial bit clock that is phase locked to the serial 10-bit data stream. In this embodiment, the recovered clock is at 125 MHz. For de-serialization, the recovered clock is used in sampling the serial 10-bit data stream and converts the serial data into parallel data.

The de-serialized data is aligned, i.e., in “byte align” step. In this step, the boundary between consecutive 10-bit symbols is determined and the de-serialized data is aligned to the boundary. The aligned data packet is further sent to the “106/8B decoder” and decoded to 8-bit data. The 8-bit data enters a FIFO circuit and is passed downstream to be assembled into PWM data, i.e., in the “PWM data assembled” step. The PWM data include the 18-bit data for R, G, and B LEDs, respectively, as well as the clock data (“RCV_DW_CLK”) and SRAM Write Enable control signal (“SRAM_WR_EN”). Examples of the configuration of the D-word based data packet from the FIFO have been disclosed elsewhere, e.g., in U.S. Pat. No. 9,747,872. As such, the receiver circuitry sends write-enable PWM R/G/B data to the LED driver circuitry.

In the LED driver circuitry, the PWM data is written into a double buffer (“LED Driver SRAM Frame Buffer Ping” and “LED Driver SRAM Frame Buffer Pong”), under the control of the “Set_ping” signal, using the double buffering technique. Data from the double buffer is combined in a multiplexer and sent to the LED driver circuitry (i.e., “LED PWM Current Driver Circuitry”), which drives the LED array. Since the receiver circuitry and the driver circuitry are both integrated on one chip, parallel data from the receiver circuit can be directly written into the double buffer.

The control settings for receiver circuitry and for the LED driver circuitry are stored in their respective registers. Both registers are accessible through an I2C slave.

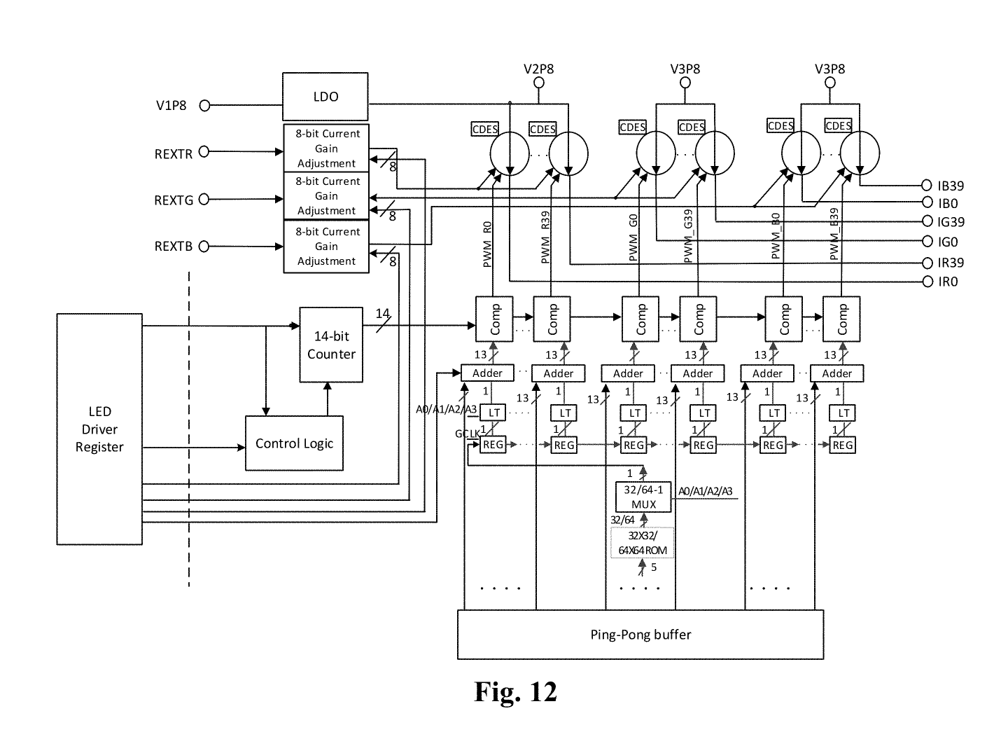

FIG. 12 is a schematic diagram showing an exemplary LED driver circuit of the current invention. The driver circuit includes a plurality of PWM engines, which receive gray scale values from the LED Driver Register and R/G/B PWM data and a global clock signal from the double buffer and generate PWM signals for a plurality of current sources, i.e., PWM_RO to PWM_R39, PWM_GO to PWM_G39, and PWM_BO to PWM B39. The current sources in turn provides 120 current outputs, i.e., IB0 to IB39, IG0 to IG39, and IR0 to IR39. Each current output is operatively connected to a common anode (or cathode) bus in the LED array. The current sources are also coupled to a low dropout regulator (LDO) three 8-bit Current Gain Adjustment circuits, which implement global gain adjustment to the current outputs. As such, the current sources provide constant current to drive the LED array. The current gain adjustment settings are provided by the LED Driver Register, which is accessible via the I2C slave (shown in FIG. 11).

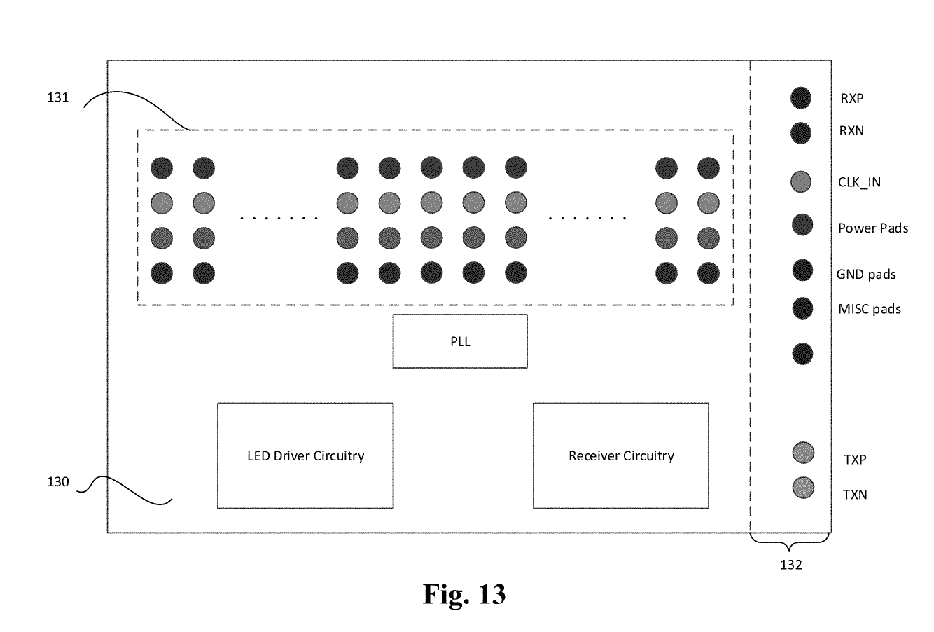

FIG. 13 provides a schematic diagram of the LPU (130). It has an array of IO pads (131) for connections with the scan lines in the interconnect circuitry. For example, one of the IO pads (131) is connected to the scan line (35) via the through hole (36) in FIG. 3. Each scan line in the interconnect layer has its corresponding IO pad on the LPU. The LPU also contains the driver circuitry, the receiver circuitry, as well as the PLL circuitry. The PLL circuitry generates internal a high speed clock signal to be fed to the receiver circuitry and the LED drivers.

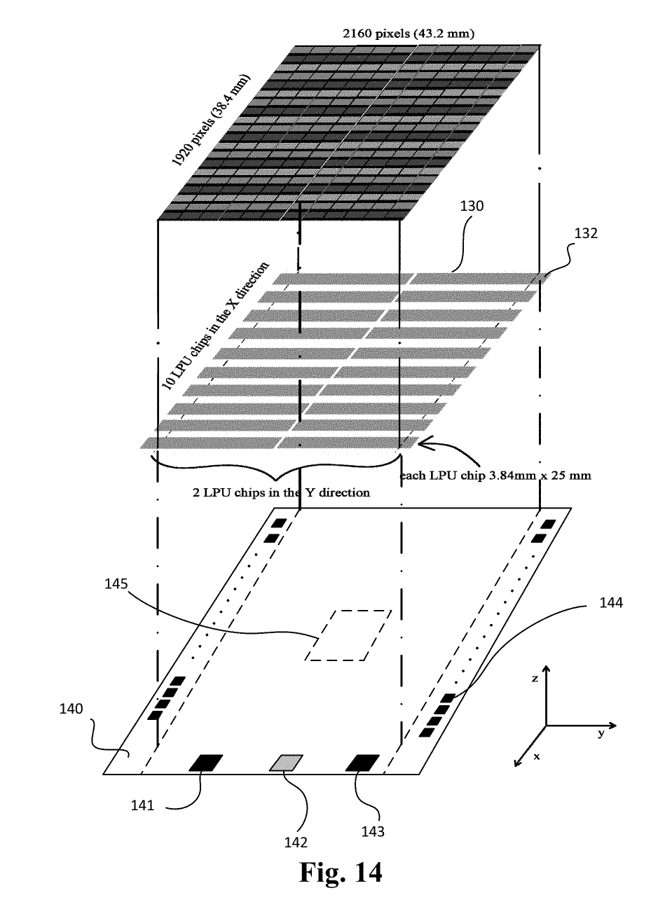

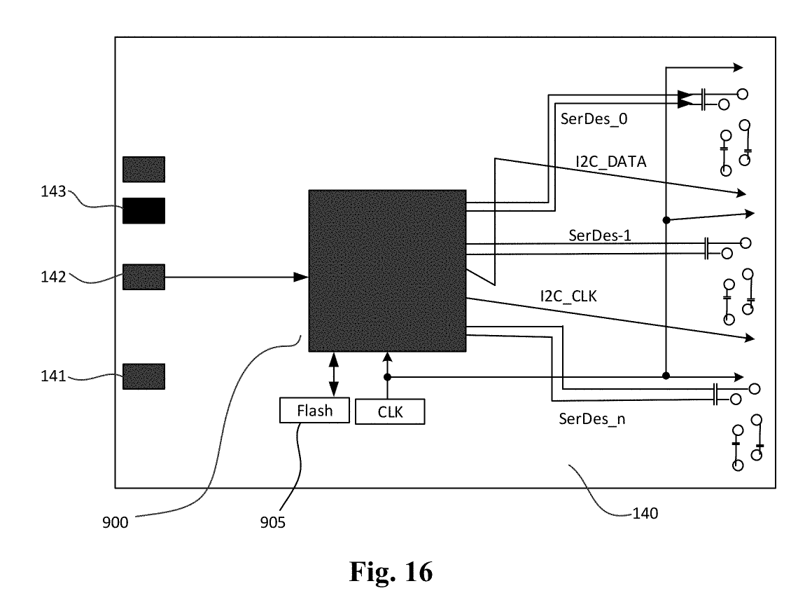

FIGS. 14-16 illustrate the method to bond the monolithic LED module with the LPU chips and the substrate, i.e., a back-board PCB. FIG. 16 shows an array of LPU chips that replace the array of driver chips in FIG. 6. The LPU chip has the same dimension as the driver chip in FIG. 6. Similar to the embodiment shown in FIG. 6, the LPU chips are wafer bonded to the LED modules, establishing electrical connections with the LED modules through the interconnect circuit and leaving an exposed portion of the LPU chip outside the footprint of the LED array.

Referring back to FIG. 13, the exposed portion of the LPU chip (132) has a number of connection points and pads, including those for data-in (RBP, RXN), data-out (TXP, TXN), clock signal (CLK_IN), power supply (Power Pads), ground (GND pads), pad to connect with the I2C bus (I2C bus), and pads for additional connections (MISC pads).

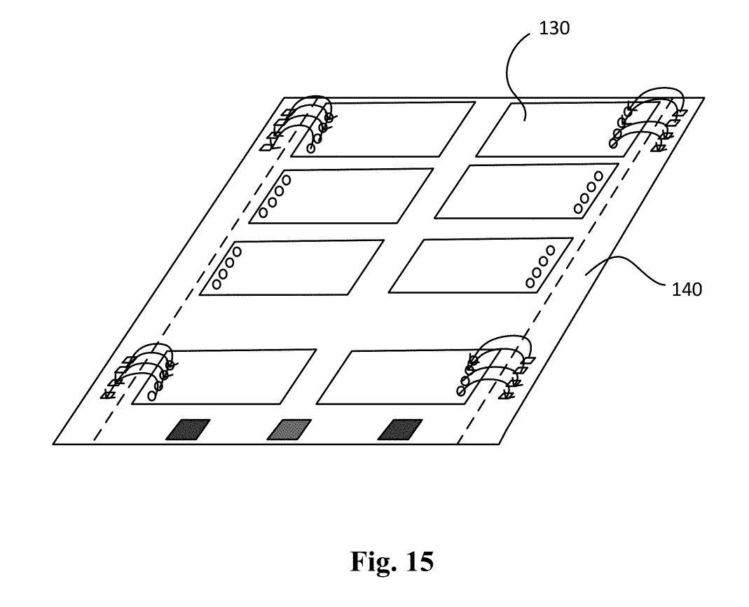

FIG. 14 further provides a substrate (e.g., a PCB board), which is larger than the footprint of the LPU array. Around the periphery of the substrate there are ports and connection pads for receiving external feeds, e.g., a human interface port (141), a video port for connection to a video source (142), a port with a power supply (143), and a number of IO pads for connections with the LPU chips. The transmitter circuit (145) may be installed on the backside of the substrate. FIG. 15 shows that the IO pads on the substrate are wire-bonded to the IO pads on the LPU chips. Note that during manufacturing the LPU chips may be first bonded with the LED modules and then wired-bonded to the substrate, or vice visa.

FIG. 16 shows the backside of the substrate 140 that is opposite to the side in contact with the LPU array. The transmitter (905) receives data input from a video processor via a connection port (142). It is also coupled with a flash memory (905) as well as a clock signal. The transmitter connects to the various connection pads via a number of traces.

Embodiments of the present disclosure have been described in detail. Other embodiments will become apparent to those skilled in the art from consideration and practice of the present disclosure. Accordingly, it is intended that the specification and the drawings be considered as exemplary and explanatory only, with the true scope of the present disclosure being set forth in the following claims.

What is claimed is:

1. An LED display device comprising:
an LED display having an array of LED pixels;
a transmitter comprising a memory storing a Gamma correction lookup table and a buffer for storing a LED calibration data, wherein the transmitter receives a data packet from a data source, performs Gamma encoding and LED calibration to the data packet;
a plurality of receivers coupled to the transmitter and receive the data packet from the transmitter; and
a plurality of LED driver groups, each LED driver group comprising a plurality of LED drivers that drive the array of LED pixels, and each LED driver group is coupled to a corresponding receiver among the plurality of receivers and transmits the data packet received from the receiver to the LED pixel.

2. The LED display device of claim 1, wherein the transmitter is coupled to a flash memory storing the Gamma correction lookup table and the LED calibration data, whereby the flash memory provides the Gamma correction lookup table and the LED calibration data to the transmitter.

3. The LED display device of claim 1, wherein the transmitter and the plurality of receivers are serially connected using a plurality of transformerless serial links.

4. The LED display device of claim 3, wherein each of the plurality of transformerless serial links is a SerDes link.

5. The LED display device of claim 1, wherein each LED driver group and the corresponding receiver are integrated on an integrated receiver/driver chip.

6. The LED display device of claim 1, wherein the array of LED pixels are bonded to a plurality of integrated receiver/driver chips so that the plurality of LED drivers in the LED driver group are connected to the array of LED pixels.

7. The LED display device of claim 1, further comprising a substrate having the transmitter mounted thereon and a plurality of connection points for receiving external feeds to the LED display device.

8. The LED display device of claim 7, wherein the substrate is bonded to the plurality of integrated receiver/driver chips.

9. The LED display device of claim 7, wherein the external feeds to the LED display device are selected from the group consisting of a human interface cable, a power cable, and a video source cable.

10. The LED display device of claim 7, wherein the LED array is a monolithic quantum dot LED array or a monolithic organic LED array.

11. The LED display device of claim 1, wherein the LED array is connected to the LED driver in a common cathode configuration.

12. A chip for an LED display device, comprising a receiver circuitry for receiving data packets from a data source and generating PWM data; and a driver circuitry that provides a plurality of current sources to drive an LED array.

13. The chip according to claim 12, wherein the receiver circuitry comprises a first analog front-end circuit that receives a data stream, wherein the first analog front-end circuit performs signal sampling, clock recovery, and de-serialization of the data stream;
an alignment circuit for aligning the de-serialized data stream;
a decoder coupled to the alignment circuit for decoding the data stream from the alignment circuit; and
a first-in-first-out circuit coupled to the decoder for outputting the decoded data stream, wherein the decoded data stream is assembled to generate PWM data.

14. The chip according to claim 13, wherein the receiver circuitry further comprises an encoder coupled to the first-in-first-out circuit; and a second analog front-end circuit coupled to the encoder for outputting encoded data packets.

15. The chip according to claim 13, wherein the driver circuitry comprises a double buffer that receives PWM data from the receiver circuitry; a plurality of PWM engines coupled to the double buffer and receive the PWM data form the double buffer; a plurality of current sources coupled to and driven by the plurality of PWM engines; and a plurality of current gain adjustment circuits coupled to the plurality of current sources.

16. The chip according to claim 12, further comprising a group of bonding pads for bonding with the LED array.

17. A method of operating an LED display device, comprising:
sending a data packet to a transmitter;
performing Gamma encoding to and calibrating the data packet in the transmitter;
transmitting the data packet via one or more SerDes links to an integrated receiver/driver chip;
processing the data packet to generate PWM data;
driving an array of LED pixels using the PWM data.

18. The method of claim 17, wherein the integrated receiver/driver chip comprises a receiver circuitry for receiving data packets and generating PWM data, and a driver circuitry that provides a plurality of current sources to drive the array of LED pixels.

19. The method of claim 18, wherein the array of LED pixels is an array of monolithic quantum dot LED pixels or an array of monolithic organic LED pixels.
